(19) United States
(12) Patent Application Publication
(10) Pub. No.: US 2003/0217204 A1
(43) Pub. Date: Nov. 20, 2003

(54) Method for determining a data transmission mode of a hard disk drive

(75) Inventor: Takeru Ono, Kawasaki-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/150,079

(22) Filed: May 20, 2002

(51) Int. Cl. G06F 13/00

(52) U.S. Cl. 710/33; 702/182

(57) ABSTRACT

At the start up of a system, transfer modes an HDD supports are confirmed and the fastest mode is selected from the transfer modes that the system and the HDD support in common. A test transfer of data is performed between the HDD and a memory in the selected transfer mode. In the event of an error, the transfer mode is changed to a transfer mode which is one rank lower in transfer rate than the current mode. Changing of the transfer modes is repeated until no error to occur in the test transfer. A transfer mode in which no error occurs in the test transfer is decided as a mode to be used.

### BACKGROUND OF THE INVENTION

The present invention relates to a method which, in a system that uses a hard disk drive (hereinafter referred to as an HDD) as a recording medium, decides a transmission mode of the HDD.

The HDD is generally used as a storage medium for data and programs in personal computers and various devices. The HDD generally supports various data transfer modes. For example, HDDs that conform to the ATA (ATattachment) specifications support data transfer modes including:

PIO mode 0-4

Multiword DMA mode 0-2

Ultra DMA mode 0-5

From those data transfer modes, the HDD control system normally selects and uses the fastest one of data transfer modes supported in common by the system and the HDD.

However, as the HDD data transfer rate increases, operationally unstable elements increase and the possibility of data transfer errors increases. For example, data transfer errors are expected to be caused by the effects of temperature/humidity of the usage environment, the shortage of data setup/hold time due to variations in HDD manufacturing lots, mixing of noise into the HDD bus through the HDD harness, etc. Examples of measures against these data transfer errors include a method in which the system repeats retry (retransfer) until data can be transferred normally. However, if the frequency of retry is high, the system performance will be degraded considerably.

### BRIEF SUMMARY OF THE INVENTION

The object of the present invention is to provide a method whereby the data transfer rate of an HDD is maintained at maximum according to conditions, and is free from data transfer errors.

In order to achieve the above object, according to one aspect of the present invention, there is provided a method for, in a system that has a hard disk drive and a memory, deciding a data transfer mode of the hard disk drive comprising: confirming transfer modes that the hard disk drive supports at start up of the system; selecting one of the transfer modes confirmed; performing a test transfer of data between the hard disk drive and the memory in the selected transfer mode; determining whether an error has occurred in the test transfer; in the event that an error has occurred in the test transfer, changing the transfer mode to a transfer mode which is one rank lower in transfer rate than the current mode and performing a test transfer of data between the hard disk drive and the memory; repeating changing of the transfer modes until no error comes to occur in the test transfer; and deciding a transfer mode in which no error occurs in the test transfer as a mode to be used. In this way, the optimum transfer mode of the HDD is decided each time the system is started.

### BRIEF DESCRIPTION OF THE DRAWINGS

FIG. 1 is a schematic block diagram of a digital copying machine to which the present invention is applied;

FIG. 2 illustrates, in a block diagram form, components which are particularly associated with the present invention in the main control unit 100 of FIG. 1;

FIG. 3 is a flowchart illustrating the operation at the start of the system according to the present invention;

FIG. 4 is a flowchart illustrating an example of a HDD data transfer mode select method based on test transfers;

FIG. 5 is a flowchart illustrating an HDD transfer error monitoring operation at the time of normal operation; and

FIG. 6 is a flowchart illustrating the operation of another embodiment for HDD transfer error monitoring at the time of normal operation.

### DETAILED DESCRIPTION OF THE PREFERRED EMBODIMENTS

Hereinafter, the HDD data transfer mode deciding method of the present invention will be described mainly using a digital copying machine; however, the present invention is not restricted to the digital copying machine but can be applied to various systems that use an HDD as a storage medium.

FIG. 1 is a block diagram schematically illustrating the configuration of a digital copying machine (image forming apparatus) 10 as an example of a device to which the present invention is applied. The digital copying machine 10 includes a scanner unit 300 which reads the image of an original and provides image data corresponding to the original image, a printer unit 400 which forms an image on paper based on the image data from the scanner unit 300, a control panel unit 200 as a user interface, and a main control unit 100 which controls all components in the digital copying machine 10 based on user commands entered via the control panel unit 200.

The main control unit 100 can perform fax transmission of image data from an original read by the scanner unit 300 via a public line, such as a telephone line, and print fax image data received over the public line by the printer unit 400. The main control unit 100 can also receive document data from an external device, such as a personal computer, over a network, such as a LAN, and print it by the printer unit 400.

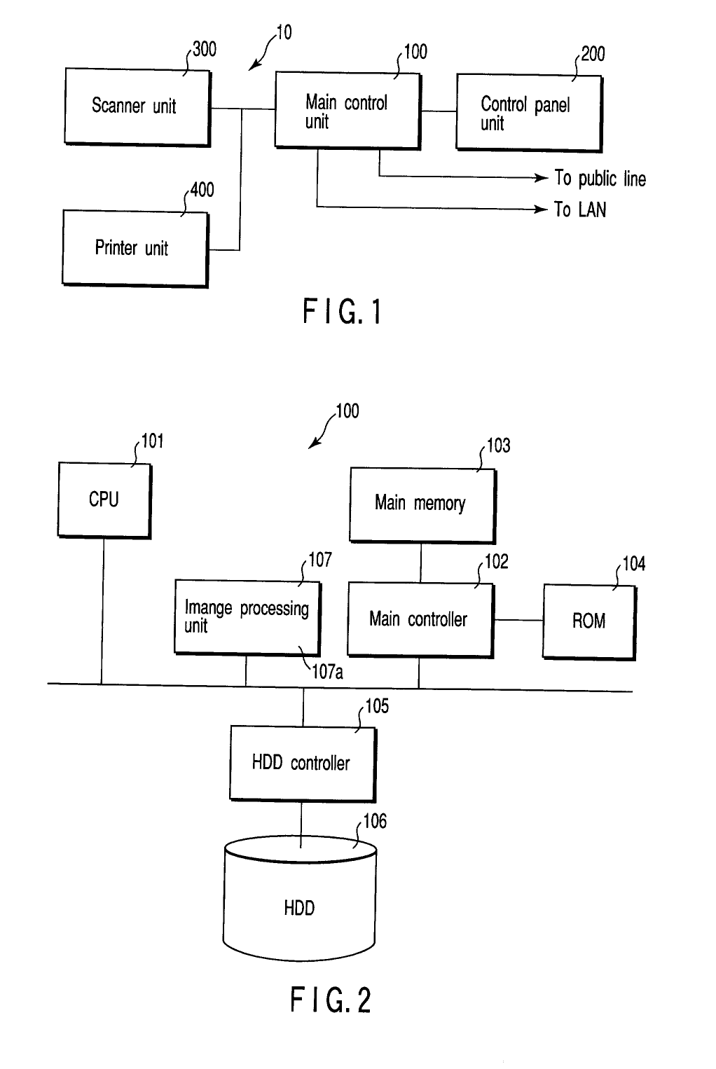

FIG. 2 illustrates, in a block diagram form, components in the main control unit 100 of FIG. 1 which are particularly associated with the HDD data transfer mode deciding method of the present invention. 101 denotes a CPU that controls the entire system, 102 a memory controller, 103 a main memory, 104 a ROM (read only memory) that stores programs including the present invention, 105 an HDD controller, 106 an HDD, and 107 an image processing unit.

The image processing unit 107 has a compression/ expansion unit 107a. The compression/expansion unit 107a compresses image data supplied from the scanner unit 300 and the like and stores it on the HDD 106. Also, the compression/expansion unit 107a reads compressed image data from the HDD 106 and carries out an expansion process on the read image data. Also, the image processing unit 107 performs image processing, such as trimming, masking, etc., on image data input from the scanner unit 300.

Usually, systems that use an HDD as a recording medium decide an HDD data transfer mode in accordance with the following procedure:

(1) The power to the system is turned on.

(2) The CPU 101 starts up the system using a start up program in the ROM 104 and expands program in the ROM on the main memory 103.

(3) The CPU 101 reads configuration information inside the HDD 106 via the HDD controller 105 and stores it in the main memory 103. Thereby, the system knows data transfer modes that the HDD 106 supports.

(4) The system selects the fastest mode from data transfer modes supported in common by the system itself and the HDD 106 and sets the selected data transfer mode in the HDD controller 105 and the HDD 106.

(5) Afterward, the system makes access to the HDD in the data transfer mode set in step (4).

The HDD data transfer mode deciding method of the present invention now will be described in detail.

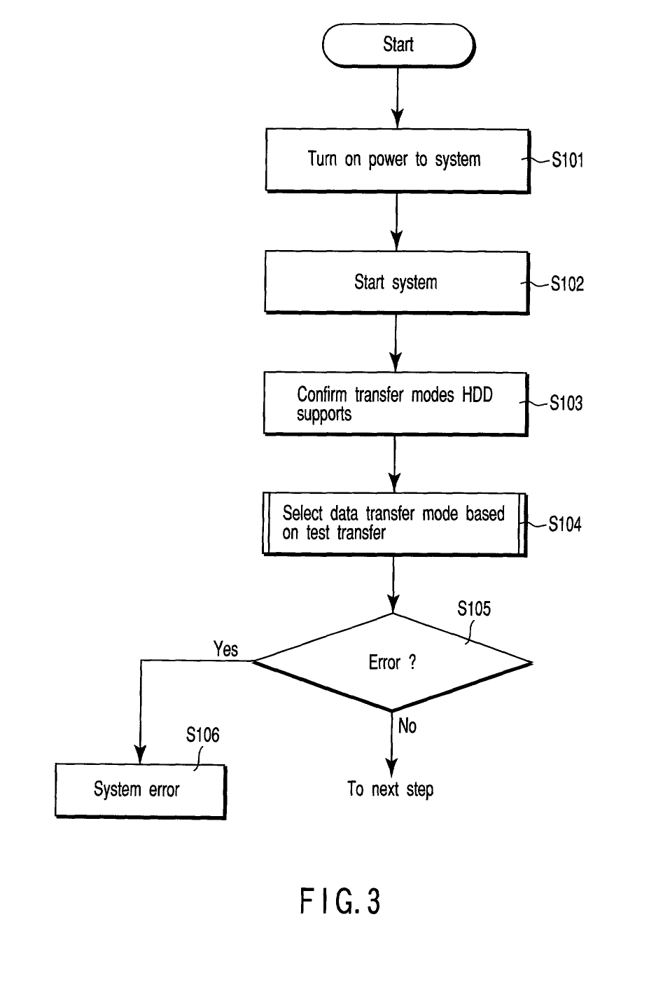

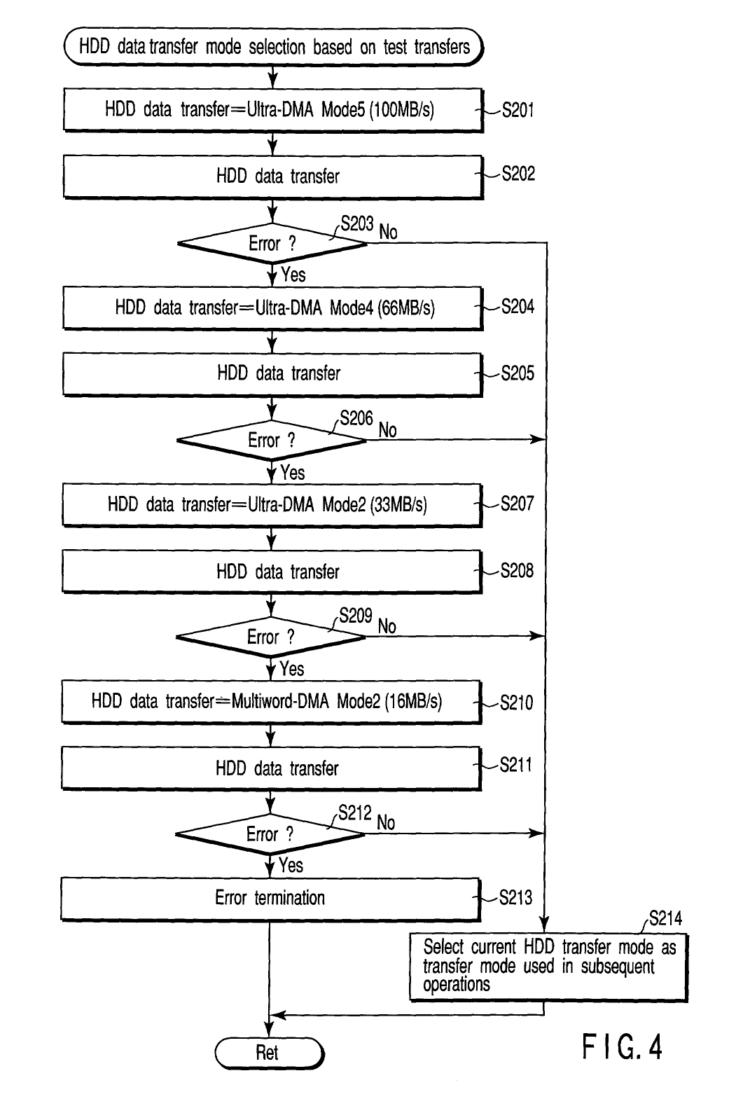

FIG. 3 is a flowchart illustrating the operation at the start of the system according to the present invention. Steps S101 to S103 in FIG. 3 are the same operations as (1) to (3) in the prior art. In the present invention, as indicated in step S104, an HDD data transfer mode is decided by performing test transfers using the HDD. A specific example of this is illustrated in FIG. 4.

FIG. 4 is a flowchart illustrating an example of an HDD data transfer mode select method based on test transfers, which is an operation controlled by the CPU 101. In this example, it is assumed that the HDD 106 is one that conforms to the ATA specifications and the maximum transfer rate that each of the system and the HDD supports is the Ultra-DMA mode 5 (transfer rate: 100 MB/s).

In step S201, the CPU 101 sets the HDD transfer mode to the Ultra-DMA mode 5 and performs a test transfer using the HDD in step S202. An example of a test transfer is as follows:

\mathring{1} Store 100-MB data on the main memory 103 in FIG. 2.

\mathring{2} Transfer the data stored in step \mathring{1} to the HDD 106 (HDD write).

\mathring{3} Transfer data in the HDD 106 transferred in step \mathring{2} to the main memory 103 (different area from that in step \mathring{1} ) (HDD read).

\mathring{4} Compare contents stored in the HDD 106 in step \mathring{1} and contents transferred to the main memory in step \mathring{3}.

\mathring{5} If a compare error has occurred in step \mathring{4}, then the test transfer is considered to be in Error. In the event that where some transfer error has occurred in the HDD transfer in step \mathring{2} or \mathring{3}, the test transfer is also considered to be in Error.

Returning to the description of FIG. 4, in step S203, the CPU 101 makes a decision of whether the result of the test transfer in step S202 is an Error. If not an Error, the procedure goes to step S214 to select the Ultra-DMA mode 5, which is the current transfer mode, as a transfer mode used in the subsequent usual operations. If an Error has occurred in step S203, the procedure goes to step S204 in which the CPU 101 drops the HDD transfer mode to the Ultra-DMA mode 4 and then performs a test transfer similar to the above in step S205. In steps S207 to S212, the CPU 101 performs test transfers in the Ultra-DMA mode 2 and Multiword-DMA mode 2 to select an Error-free transfer mode as the transfer mode used in the subsequent usual operations.

As described above, if an error has occurred in the test transfer, the CPU 101 changes the transfer mode to a transfer mode one rank lower in transfer rate, performs a test transfer of data between the HDD 106 and the memory 103, and repeats changing of the transfer mode until the test transfer comes to be free from errors. A transfer mode in which no error occurs in the test transfer is decided as the transfer mode to be used.

The HDD transfer error monitoring at the time of normal operation now will be described.

The HDD 106 stores image data from an original read by the scanner 300 by way of example. That is, the original image data read by the scanner 300 is both sent to the printer 400 on a page-by-page basis and compressed by the compression/expansion unit 107a in the main control unit 100 and then stored on the HDD 106. This is intended, for example, to recover an image lost due to a paper jam. In the event of a paper jam, image data to be printed onto the paper is read from the HDD 106, then expanded by the compression/expansion unit 107a and printed by the printer unit 400. In addition, the HDD 106 can store fax data (image data) sent/received over the public line and document data received over a LAN.

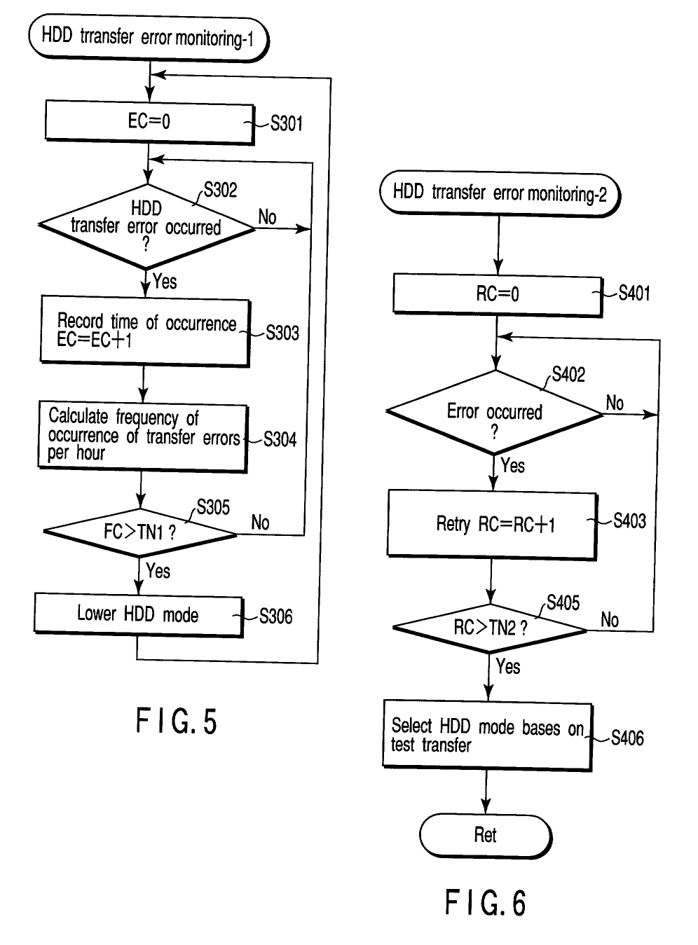

FIG. 5 is a flowchart illustrating an HDD transfer error monitoring operation at the time of normal operation. It is the CPU 101 that performs the operation in each step shown in FIG. 5.

First, in step S301, a transfer error counter EC is reset to 0. In step S302, a decision is performed as to whether an HDD transfer error has occurred in a normal operation at the time of copying an original or the like. In the event of a transfer error, the time of the occurrence is stored in a storage unit, such as the main memory 103, as in step S303 and then the value (contents) in the transfer error counter EC is incremented by one.

In step S304, the frequency of occurrence of transfer errors per unit time is calculated. This step 304 is carried out when the value in the transfer error counter EC is two or more. That is, in step S304, the frequency of occurrence of transfer errors per hour by way of example is calculated from the time of occurrence of each transfer error and the error count indicated by the transfer error counter EC.

In step S305, a decision is made as to whether the frequency of occurrence of transfer errors is more than a reference value TN1. In step 305, when the reference value TN1 is exceeded (in the case of YES), the HDD transfer mode is changed to a mode one rank lower than the current mode as in step S306. In step S306, instead of changing the transfer mode to the one-rank lower mode, an HDD transfer mode may be decided through the test transfers as shown in FIG. 4.

FIG. 6 is a flowchart illustrating the operation of another embodiment for HDD transfer error monitoring at the time of normal operation. It is the CPU 101 that performs the operation in each step shown in FIG. 6.

First, in step S401, a retry counter RC is reset to 0. In step S402, a decision is made as to whether an HDD transfer error has occurred in a normal operation at the time of copying an original or the like. In the event of a transfer error, the CPU 101 performs a retransfer of data (retry) using the HDD 106 and then adds one to the value (contents) in the retry counter RC (S403).

In step S404, a decision is made as to whether the value in the retry counter RC is larger than an allowable value TN2. In the case of less than the allowable value TN2 (in the case of NO), the flow goes to step S402. In step S402, a decision is made as to whether an error has occurred. In this case, the CPU 101 makes a decision of whether or not the retry performed in step 403 has succeeded.

In step S404, when the value in the retry counter RC is larger than the allowable value TN2 (in the case of YES), the HDD mode selection processing based on the test transfers shown in FIG. 4 is performed again as in step S405. Thereby, the transfer mode of the HDD 106 is set again to an optimum one. In step S405, instead of performing the HDD mode selection processing, the mode of the HDD 106 may be lowered by one rank as in step S306 in FIG. 5.

1. A method for, in a system that has a hard disk drive and a memory, deciding a data transfer mode of the hard disk drive comprising:
confirming transfer modes that the hard disk drive supports at the start up of the system;
selecting one of the transfer modes confirmed;
performing a test transfer of data between the hard disk drive and the memory in the selected transfer mode;
determining whether an error has occurred in the test transfer;
in the event that an error has occurred in the test transfer, changing the transfer mode to a transfer mode which is one rank lower in transfer rate than the current mode and performing a test transfer of data between the hard disk drive and the memory;
repeating changing of the transfer modes until no error comes to occur in the test transfer; and
deciding a transfer mode in which no error occurs in the test transfer as a mode to be used.

2. The method according to claim 1, wherein the selecting step selects the fastest transfer mode from the transfer modes that the system and the hard disk drive support in common.

3. The method according to claim 1, further comprising:
monitoring whether a transfer error associated with the hard disk drive has occurred during normal operation of the system;
in the event that the transfer error has occurred, recording the time of the occurrence and incrementing the value in an error counter by one;
calculating the frequency of occurrence of transfer errors from the times at which the transfer errors occurred and the value in the error counter; and
when the frequency of occurrence of the transfer errors is larger than a predetermined value, changing the transfer mode to a mode which is one rank lower in transfer rate than the mode currently in use.

4. The method according to claim 3, further comprising:
performing a test transfer of data between the hard disk drive and the memory in the transfer mode changed to the mode which is one rank lower in transfer rate;
determining whether an error has occurred in the test transfer;
in the event that an error has occurred in the test transfer, changing the transfer mode to a transfer mode which is one rank lower in transfer rate than the current mode and performing a test transfer of data between the hard disk drive and the memory;
repeating changing of the transfer modes until no error occurs in the test transfer; and
deciding a transfer mode in which no error occurs in the test transfer as a mode to be used.

5. The method according to claim 1, further comprising:
monitoring whether a transfer error associated with the hard disk drive has occurred during normal operation of the system;
in the event that an transfer error has occurred, performing a retransfer and incrementing the value in a retry counter by one; and
when the value in the retry counter is larger than a predetermined value, changing the transfer mode to a mode which is one rank lower in transfer rate than the mode currently in use.

6. The method according to claim 5, further comprising:
performing a test transfer of data between the hard disk drive and the memory in the transfer mode changed to the mode which is one rank lower in transfer rate;
determining whether an error has occurred in the test transfer;
in the event that an error has occurred in the test transfer, changing the transfer mode to a transfer mode which is one rank lower in transfer rate than the current mode and performing a test transfer of data between the hard disk drive and the memory;
repeating changing of the transfer modes until no error occurs in the test transfer; and
deciding a transfer mode in which no error occurs in the test transfer as a mode to be used.

7. An image forming apparatus comprising:
a scanner unit for reading an original and providing image data corresponding to the original image;
a memory section for storing data containing the image data provided from the scanner section;
a compression section for compressing the data stored in the memory section;
a hard disk drive for storing the data compressed by the compression section;
an expansion section for expanding the data stored on the hard disk drive and storing it in the memory section;
a printer section for forming an image corresponding to the image data provided from the memory section;
a confirmation section for confirming transfer modes the hard disk drive supports;
a selection section for selecting one of the transfer modes confirmed by the confirmation section;
a test transfer section for performing a test transfer of data between the hard disk drive and the memory section in the transfer mode selected by the selection section;
a determining section for determining whether an error has occurred in the test transfer performed by the test transfer section;
a transfer mode changing section for, in the event that an error has occurred in the test transfer, changing the transfer mode to a transfer mode which is one rank lower in transfer rate than the current mode and performing a test transfer of data between the hard disk drive and the memory;
a repeating section for repeating changing of the transfer modes until no error occurs in the test transfer; and
a deciding section for deciding a transfer mode in which no error occurs in the test transfer as a mode be used.

8. The apparatus according to claim 7, further comprising:
a monitoring section for monitoring whether a transfer error associated with the hard disk drive has occurred during normal operation of the image forming apparatus using one or both of the scanner section and the printer section;
a recording section for, in the event that the transfer error has occurred, recording the time of the occurrence and incrementing the value in an error counter by one;
a calculation section for calculating the frequency of occurrence of transfer errors from the times at which the transfer errors occurred recorded by the recording section and the value in the error counter; and
a changing section for, when the frequency of occurrence of the transfer errors calculated by the calculation section is larger than a predetermined value, changing the transfer mode to a mode which is one rank lower in transfer rate than the mode currently in use.

9. The apparatus according to claim 7, further comprising:
a monitoring section for monitoring whether a transfer error associated with the hard disk drive has occurred during normal operation of the image forming apparatus using one or both of the scanner section and the printer section;
an incrementing section for, in the event that the transfer error has occurred, performing a retransfer and incrementing the value in a retry counter by one; and
a changing section for, when the value in the retry counter incremented by the incrementing section is larger than a predetermined value, changing the transfer mode to a mode which is one rank lower in transfer rate than the mode currently in use.
